(19) United States
(12) Patent Application Publication
(10) Pub. No.: US 2013/0200858 A1
(43) Pub. Date: Aug. 8, 2013

(54) ELECTRONIC APPARATUS, CONTROL METHOD OF ELECTRONIC APPARATUS, AND CONTROL PROGRAM OF ELECTRONIC APPARATUS

(71) Applicant: Kazuhiko TSUJI, Hamura-shi (JP)

(72) Inventor: Kazuhiko TSUJI, Hamura-shi (JP)

(73) Assignee: KABUSHIKI KAISHA TOSHIBA, Tokyo (JP)

(21) Appl. No.: 13/609,004

(22) Filed: Sep. 10, 2012

(30) Foreign Application Priority Data
Feb. 6, 2012 (JP) 2012-023543

(51) Int. Cl. H02J 7/00

(52) U.S. Cl. 320/163

(57) ABSTRACT

According to one embodiment, an electronic apparatus includes: a judging section configured to judge whether a current time is in a time slot during which charging of a battery is prohibited and which is set so as to be different from a peak shift time slot; a calculating section configured to calculate an average power consumption while the electronic apparatus is powered on if the judging section judges that the current time is in the battery charging prohibition time slot; a detecting section configured to detect whether the electronic apparatus is in a power-off state or a sleep state; and a charging control section configured to control charging of the battery so that the charging is performed with power that is lower than the calculated average power consumption if the detecting section detects that the electronic apparatus is in a power-off state or a sleep state.

### CROSS REFERENCE TO RELATED APPLICATION (S)

The application is based upon and claims the benefit of priority from Japanese Patent Application No. 2012-023543 filed on Feb. 6, 2012, the entire contents of which are incorporated herein by reference.

### BACKGROUND

1. Field

The present invention relates to an electronic apparatus, a control method of an electronic apparatus, and a control program of an electronic apparatus.

2. Description of the Related Art

It is known that a power demand peak time slot exists in, for example, midday hours of summer days. It is necessary to reduce a power consumption in such a power demand peak time slot.

To this end, electronic apparatus (e.g., notebook personal computers (PCs) and TV receivers) have spread which have a function of suspending the reception of power from a power source in the peak time slot, storing electric energy by charging a battery during time slots of low power demand, and using the electric energy stored in the battery during the peak time slot.

Shifting power use hours to reduce a power consumption in the power demand peak time slot in the above-described manner is called peak shifting.

For example, a technique (called a peak shift control) is known which controls a peak shift operation more effectively by setting a battery charging prohibition time slot between the power demand peak time slot and night.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 shows an appearance of an electronic apparatus (PC) according to an embodiment.

FIG. 2 is a block diagram showing the configuration of the electronic apparatus (PC) according to the embodiment.

FIG. 3 is a block diagram showing the configuration of an essential part, for peak shift control, of the electronic apparatus (PC) according to the embodiment.

FIG. 4 shows an example peak shift control setting picture which is displayed on an LCD of the electronic apparatus (PC) according to the embodiment.

FIG. 5 is a flowchart illustrating how the electronic apparatus (PC) according to the embodiment operates.

### DETAILED DESCRIPTION

According to one embodiment, an electronic apparatus includes: a judging section configured to judge whether or not a current time is in a time slot during which charging of a battery is prohibited and which is set so as to be different from a peak shift time slot; a calculating section configured to calculate an average power consumption while the electronic apparatus is powered on if the judging section judges that the current time is in the battery charging prohibition time slot; a detecting section configured to detect whether or not the electronic apparatus is in a power-off state or a sleep state; and a charging control section configured to control charging of the battery so that the charging is performed with power that is lower than the calculated average power consumption if the detecting section detects that the electronic apparatus is in a power-off state or a sleep state.

An embodiment will be hereinafter described with reference to the drawings.

In ordinary peak shifting, charging of the battery of an electronic apparatus (e.g., personal computer (PC)) is prohibited in a charging prohibition time slot. As a result, because of the time shifting, the residual capacity of the battery may become so small due to its discharge that an AC adapter or the like needs to be used.

In the embodiment, as described later, even in a charge prohibition time slot of peak shifting, the power consumption of an electronic apparatus (PC) 10 is monitored while it is powered on (charging is prohibited) and an average power consumption is determined. If the electronic apparatus (PC) 10 makes a transition to a power-off state or a sleep state, charging of a battery 22 is permitted with the above-determined average power consumption as an upper limit, whereby a sufficient battery residual capacity is secured even in the charging prohibition time slot of peak shifting.

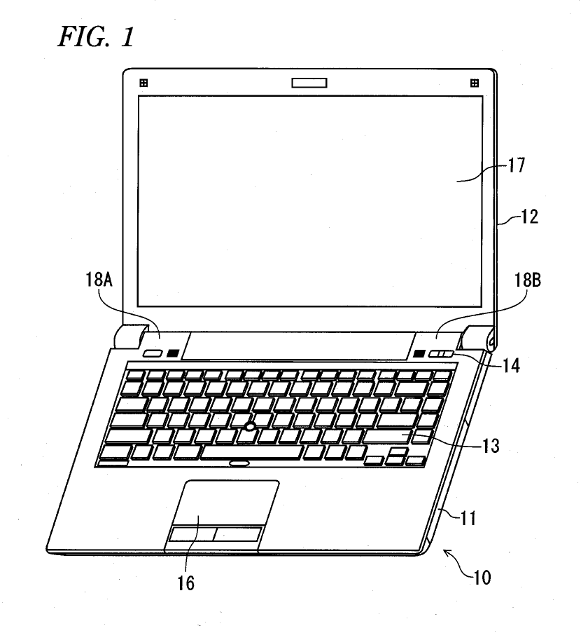

FIG. 1 shows an appearance of the electronic apparatus (PC) 10 according to the embodiment which is a notebook PC. The concept of the embodiment can be applied to not only personal computers but also tablet PCs, cell phones, portable electronic apparatus, TV receivers, etc.

The electronic apparatus (PC) 10 is composed of a computer main body 11 and a video display unit 12. The video display unit 12 incorporates an LCD (liquid crystal display) 17, for example. The video display unit 12 is attached to the computer main body 11 so as to be rotatable between an open position where the video display unit 12 exposes the top surface of the computer main body 11 and a closed position where the video display unit 12 covers the top surface of the computer main body 11.

The computer main body 11 has a thin, box-shaped cabinet, and a keyboard 13, a power button 14 for powering on and off the electronic apparatus (PC) 10, a touch pad 16, speakers 18A and 18B, etc. are arranged on the top surface of the computer main body 11.

The right side surface, for example, of the computer mainbody 11 is providedwith a USB (universal serial bus) connector (not shown) for connection of a USB cable or USB device of the USB 2.0 standard.

The back surface of the computer main body 11 is provided with an external display connection terminal (not shown) which complies with the HDMI (high-definition multimedia interface) standard, for example. The external display connection terminal is used for outputting a digital video signal to an external display.

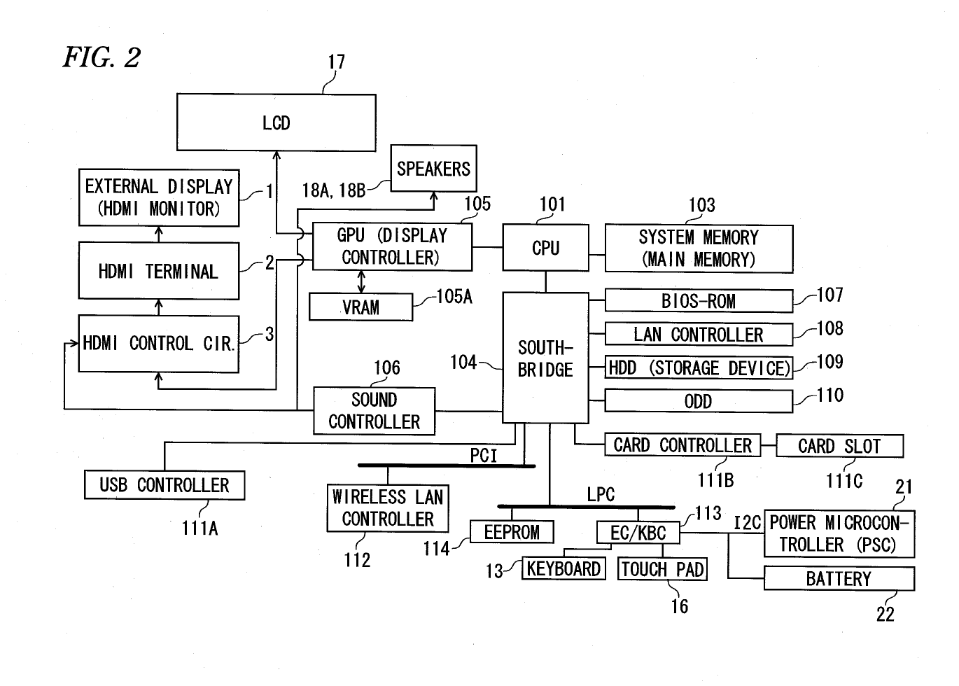

FIG. 2 is a block diagram showing the configuration of the electronic apparatus (PC) according to the embodiment. As shown in FIG. 2, the electronic apparatus (PC) 10 is equipped with a CPU (central processing unit) 101, a system memory (main memory) 103, a southbridge 104, a GPU (graphics processing unit) 105, a VRAM (video random access memory) 105A, a sound controller 106, a BIOS-ROM (basic input/output system-read only memory) 107, a LAN (local area network) controller 108, a hard disk drive (HDD; storage device) 109, an optical disc drive (ODD) 110, a USB controller 111A, a card controller 111B, a card slot 111C, a wireless LAN controller 112, an embedded controller/keyboard controller (EC/KBC) 113, an EEPROM (electrically erasable programmable ROM) 114, etc.

The CPU (SOC) 101 is a processor for controlling the operations of the individual components of the electronic apparatus (PC) 10. The CPU 101 runs a BIOS which is stored in the BIOS-ROM 107. The BIOS is programs for hardware control. The CPU 101 incorporates a memory controller for access-controlling the system memory (main memory) 103. The CPU 101 also has a function of communicating with the GPU 105 via, for example, a serial bus of the PCI Express standard.

The GPU 105 is a display controller for controlling the LCD 17 which is used as a display monitor of the electronic apparatus (PC) 10. A display signal generated by the GPU 105 is supplied to the LCD 17. The GPU 105 can also send a digital video signal to an external display 1 via an HDMI control circuit and an HDMI terminal 2. The HDMI terminal 2 is the above-mentioned external display connection terminal. The HDMI terminal 2 makes it possible to send a non-compressed digital video signal and digital audio signal to the external display 1 such as a TV receiver through a single cable. The HDMI control circuit 3 is an interface for sending a digital video signal to the external display 1 (called an HDMI monitor) via the HDMI terminal 2.

The southbridge 104 controls individual devices on a PCI (peripheral component interconnect) bus and an LPC (low pin count) bus. The southbridge 104 incorporates an IDE (integrated drive electronics) controller for controlling the HDD 109 and the ODD 110. The southbridge 104 also has a function of communicating with the sound controller 106.

The sound controller 106, which is a sound source device, outputs reproduction subject audio data to the speakers 18A and 18B or the HDMI control circuit 3. The LAN controller 108 is a wired communication device for performing a wired communication of the IEEE 802.3 standard, for example. On the other hand, the wireless LAN controller 112 is a wireless communication device for performing a wireless communication of the IEEE 802.11g standard, for example. The USB controller 111A communicates with an external device that complies with the USB 2.0 standard, for example.

For example, the USE controller 111A is used for receiving an image data file that is stored in a digital camera. The card controller 111B writes and reads data to and from a memory card such as an SD card that is inserted in the card slot 111C which is provided in the computer main body 11.

The EC/KBC 113 is a one-chip microcomputer in which an embedded controller for power management and a keyboard controller for controlling the keyboard 13 and the touch pad 16 are integrated together. The EC/KBC 113 has a function of powering on and off the electronic apparatus (PC) 10 in response to a user manipulation of the power button 14.

In the embodiment, for example, a display control is performed when the CPU 101 causes execution of programs stored in the system memory (main memory) 103, the HDD 109, or the like.

An OS (operating system), which is stored in the HDD 109, for example, is software which provides common basic functions (e.g., input/output functions such as keyboard input and screen output and disc and memory management) to be used by many kinds of application software and which manages the entire computer system.

In the embodiment, the electronic apparatus (PC) 10 is equipped with a power microcontroller (PSC) 21 and a battery 22. The power microcontroller 21 operates so that the electronic apparatus (PC) 10 can be used properly even in the case where it accommodates peak shifting.

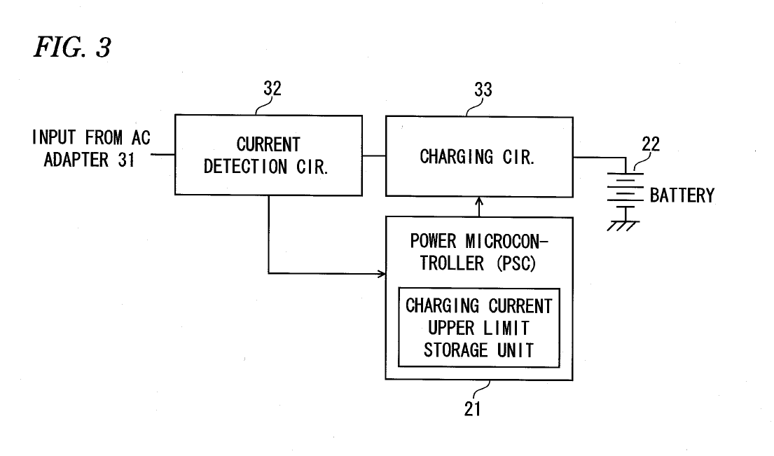

FIG. 3 is a block diagram showing the configuration of an essential part, for peak shift control, of the electronic apparatus (PC) 10 according to the embodiment. Commercial power is input to the electronic apparatus (PC) 10 via an AC adapter 31, for example.

A current detection circuit 32 and a charging circuit 33 are provided in the electronic apparatus (PC) 10 in the form of hardware, for example. The current detection circuit 32 detects power being consumed by the electronic apparatus (PC) 10 according to instructions from the power microcontroller 21.

The charging circuit 33 charges the battery 22 according to instructions from the power microcontroller 21. As shown in FIG. 3, the power microcontroller 21 is equipped with a charging current upper limit storage unit (charging current limit power register).

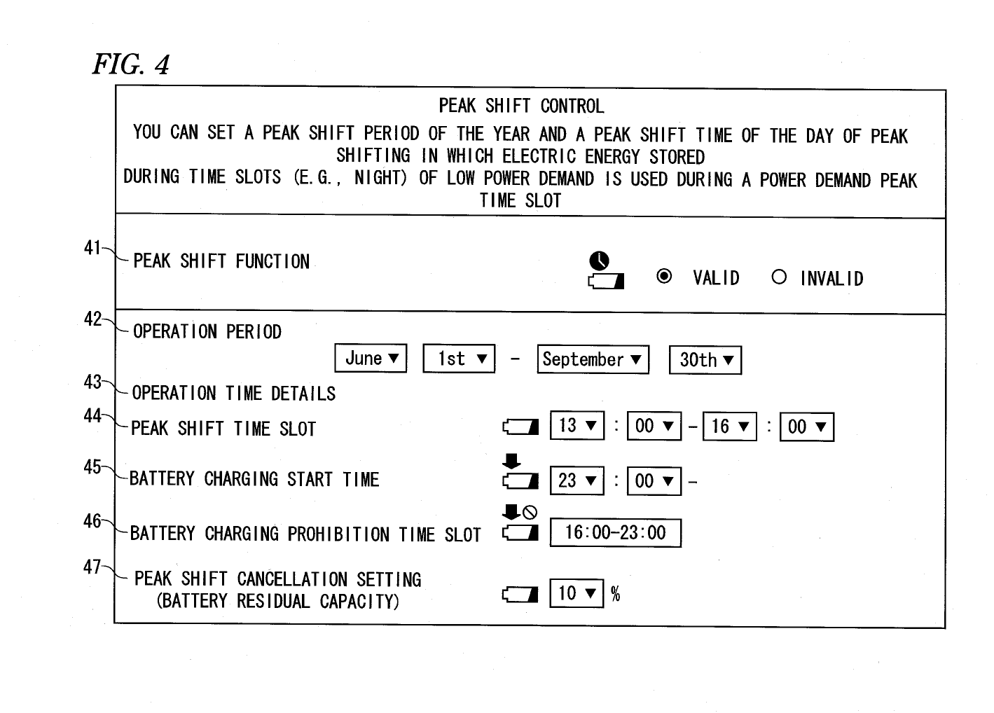

FIG. 4 shows an example peak shift control setting picture which is displayed on the LCD 17 of the electronic apparatus (PC) 10 according to the embodiment.

In the embodiment, if the user manipulates, for example, the keyboard 13 or the touch pad 16, a peak shift control setting picture as shown in FIG. 4 is displayed on the LCD 17.

The user can set details of a prescribed peak shift control while looking at the peak shift control setting picture. The peak shift control setting picture has, as an explanation of the peak shift control, a statement “You can set a peak shift period of the year and a peak shift time of the day of peak shifting in which electric energy stored during time slots (e.g., night) of low power demand is used during a power demand peak time slot.”

In the embodiment, for an item “peak shift function” 41, “valid” or “invalid” can be designated selectively. In FIG. 4, “valid” is selected which means that the peak shift control should be performed.

An item “operation period” 42 is specified to be “May 1st” to “September 30th.” The operation period 42 can also be changed as appropriate by the user.

For an item “operation time details” 43, items “peak shift time slot” 44, “battery charging start time” 45, and “battery charging prohibition time slot” 46 can be specified. In FIG. 4, the peak shift time slot 44 is specified to be “13:00” (PM 1:00) to “16:00” (PM 4:00). The peak shift time slot 44 can also be changed as appropriate by the user.

The battery charging start time 45 is specified to be “23:00” (PM 11:00). The battery charging start time 45 can also be changed as appropriate by the user.

The battery charging prohibition time slot 46 is specified to be “16:00” (PM 4:00) to “23:00” (PM 11:00). The battery charging prohibition time 46 can also be changed as appropriate by the user.

The battery charging prohibition time slot 46 may be set automatically so as to be a time slot between the end of the peak shift time slot 44 and the battery charging start time 45.

In the embodiment, an item “peak shift cancellation setting (battery residual capacity)” 47 can be made as a condition of peak shift cancellation. In FIG. 4, the peak shift cancellation setting (battery residual capacity) 47 is made so that the prohibition of charging of the batter 22 is canceled if the residual capacity of the batter 22 becomes 10% or less. The peak shift cancellation setting (battery residual capacity) 47 can be changed as appropriate. For example, the peak shift cancellation setting (battery residual capacity) 47 can be changed to 15%, 20%, or 25% by a user manipulation.

As described above, in the embodiment, the setting items of the peak shift control include the operation period 42, the operation time details 43, and the peak shift cancellation setting (battery residual capacity) 47. The operation time details 43 include the peak shift time slot 44, the battery charging start time 45, and the battery charging prohibition time slot 46.

In the embodiment, if the electronic apparatus (PC) 10 is not in a power-on state (i.e., it is in a power-off state or a sleep state) in the battery charging prohibition time slot of the peak shift control, the power microcontroller 21 calculates a charging current with an average power consumption (determined while the electronic apparatus (PC) 10 was powered on) as an upper limit power and stores the calculated charging current in the charging current upper limit storage unit. For example, an average power consumption thus determined is about 10 to 15 W.

In the embodiment, the state that the electronic apparatus (PC) 10 is not powered on (i.e., it is in a power-off state or a sleep state) is as follows. For example, the state that the electronic apparatus (PC) 10 it is not powered on is that it is in one of statuses “S3,” “S4,” and “S4” that are defined as sleep states in the power saving standard “ACPI (Advanced Configuration and Power Interface).” In the standard ACPI, a status “S0” is defined as a full operation state, “S1” is defined as a low power consumption state (the processor and the chip set are both powered off), and “S2” is defined as another low power consumption state (the processor and the cache are powered off and the chip set is powered on). The status “S3” is defined as a standby state, “S4” is defined as an operation suspension state, and “S5” is defined as a power-off state caused by software.

The calculated charging current is stored in the BIOS-ROM 107, for example.

The power microcontroller 21 controls the charging circuit 33 using the calculated charging current value to charge the battery 22 with the calculated charging current as an upper limit.

More specifically, in the embodiment, if the electronic apparatus (PC) 10 is in a power-on state in the charging prohibition time slot (16:00 to 23:00) of the peak shift control, the power microcontroller 21 monitors the power being consumed by the electronic apparatus (PC) 10 using the current detection circuit 32. The power microcontroller 21 calculates an average power consumption of the electronic apparatus (PC) 10 being in a power-on state on the basis of power consumption values that were monitored while it was powered on.

A description will be made of why in the embodiment an average power consumption is calculated on the basis of power consumption values that were monitored while the electronic apparatus (PC) 10 was powered on.

The user uses the electronic apparatus (PC) 10 while it is powered on. And the manner of use of the electronic apparatus (PC) 10 varies depending on the user and the situation. Therefore, in the embodiment, if the electronic apparatus (PC) 10 is in a power-on state in the charging prohibition time slot (16:00 to 23:00), the power being consumed by the electronic apparatus (PC) 10 is monitored and an average power consumption is calculated on the basis of resulting power consumption values.

In the embodiment, as described above, if the electronic apparatus (PC) 10 is not in a power-on state (i.e., it is in a power-off state or a sleep state) in the in the charging prohibition time slot of the peak shift control, the power microcontroller 21 calculates a charging current that is smaller than or equal to a current corresponding to an average power consumption (determined while the electronic apparatus (PC) 10 was powered on) and stores the calculated charging current in the charging current upper limit storage unit.

The power microcontroller 21 sets the calculated charging current in the charging circuit 33 and starts charging the battery 22 with the thus-set charging current as an upper limit.

In the embodiment, since the battery 22 is charged at a restricted charging current that is smaller than or equal to a current corresponding to an average power consumption of the electronic apparatus (PC) 10 being in a power-on state.

With the above measure, the electronic apparatus (PC) 10 can be used properly even in the case where it accommodates peak shifting.

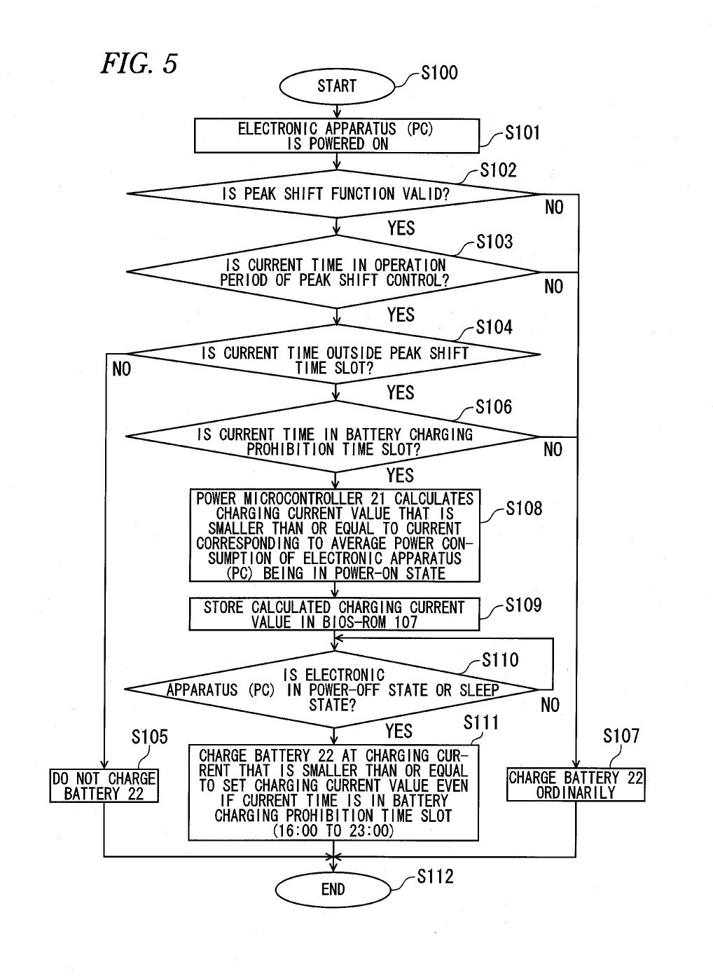

FIG. 5 is a flowchart illustrating how the electronic apparatus (PC) 10 according to the embodiment operates. The process starts at step S100.

At step S101, the user, for example, powers on the electronic apparatus (PC) 10. At step S102, it is judged whether or not the peak shift function is set valid. If it is judged that the peak shift function is set valid (S102: yes), the process moves to step S103. If not (S102: no), the process moves to step S107.

At step S103, it is judged whether or not the current time is in the preset operation period of the peak shift control. If it is judged that the current time is in the preset operation period of the peak shift control (S103: yes), the process moves to step S104. If not (S103: no), the process moves to step S107.

At step S104, it is judged whether or not the current time is outside the preset peak shift time slot. If it is judged that current time is outside the preset peak shift time slot (S104: yes), the process moves to step S106. If not (S104: no), the process moves to step S105. At step S105, the battery 22 is not charged.

At step S106, it is judged whether or not the current time is in the preset battery charging prohibition time slot. If it is judged that the current time is in the preset battery charging prohibition time slot (S106: yes), the process moves to step S108. If not (S106: no), the process moves to step S107.

At step S107, the battery 22 is charged ordinarily (i.e., the charging current is not restricted to an upper limit current corresponding to an average power consumption).

At step S108, the power microcontroller 21 calculates a charging current value that is smaller than or equal to a current corresponding to an average power consumption of the electronic apparatus (PC) 10 being in a power-on state. At step S109, the calculated charging current value is stored in the BIOS-ROM 107.

At step S110, it is judged whether or not the electronic apparatus (PC) 10 is in a power-off state or a sleep state. If it is judged that the electronic apparatus (PC) 10 is in a power-off state or a sleep state (S110: yes), the process moves to step S111. If not (S110: no), the step S110 is executed again.

At step S111, the battery 22 is charged at a charging current that is smaller than or equal to the set charging current value (stored at step S109) even if the current time is in the battery charging prohibition time slot (16:00 to 23:00). The process is finished at step S112.

As described above, in the embodiment, if the electronic apparatus (PC) 10 is in a power-off state or a sleep state, charging of the battery 22 is controlled so as to be performed with power that is lower than or equal to an average power consumption that was calculated while the electronic apparatus (PC) 10 was powered on.

More specifically, in the electronic apparatus according to the embodiment, the CPU 101 judges whether or not the current time is in the battery charging prohibition time slot which is different from the peak shift time slot. If the current time is in the battery charging prohibition time slot, the power microcontroller 21 calculates an average power consumption of the electronic apparatus while it is in a power-on state.

The CPU 101 detects whether or not the electronic apparatus is in a power-off state or a sleep state. If the electronic apparatus is in a power-off state or a sleep state in the battery charging prohibition time slot, the power microcontroller 21 controls charging of the battery 22 so that the charging is performed with power that is lower than or equal to the calculated average power consumption of the electronic apparatus being in a power-on state.

The CPU 101 causes the battery 22 to be charged at the battery charging prohibition time slot which is different from the peak shift time slot.

If a condition for cancellation of battery charging prohibition is satisfied, the CPU 101 causes the battery 22 to be charged.

As shown in FIG. 4, the battery charging prohibition time slot, the condition for cancellation of battery charging prohibition, and whether to render the peak shift function valid can be set by the user.

The CPU 101 causes the battery 22 to be charged with power that is higher than the calculated average power consumption during a time when the battery charge is not prohibited.

With the above configuration, the embodiment makes it possible to use the electronic apparatus properly even in the case where it accommodates peak shifting.

The entire control process according to the embodiment can be executed by software. Therefore, the advantages of the embodiment can easily be obtained merely by installing a program of the control process in an ordinary computer via a computer-readable storage medium that is stored with the program.

The invention is not limited to the above embodiment itself and, in the practice stage, may be embodied in such a manner that constituent elements are modified in various manners without departing from the spirit and scope of the invention. And various inventive concepts may be conceived by properly combining plural constituent elements disclosed in the embodiment. For example, several ones of the constituent elements of the embodiment may be omitted.

What is claimed is:

1. An electronic apparatus comprising:
a determination section configured to determine whether a current time is in a battery charging prohibition time slot and whether the current time is different from a peak shift time slot;
a calculator configured to calculate an average power consumption while the electronic apparatus is powered on when the determination section determines that the current time is in the battery charging prohibition time slot;
a detector configured to detect whether the electronic apparatus is in a power-off state or a sleep state; and
a charging controller configured to control charging of the battery with power that is lower than the calculated average power consumption when the detector detects that the electronic apparatus is in a power-off state or a sleep state.

2. The electronic apparatus of claim 1, wherein
the charging is performed in the battery charging prohibition time slot.

3. The electronic apparatus of claim 1, wherein
when a condition for cancellation of battery charging prohibition is satisfied, the battery is charged.

4. The electronic apparatus of claim 1, further comprising a charging prohibition time slot setting section configured to set the battery charging prohibition time slot.

5. The electronic apparatus of claim 3, further comprising
a cancellation condition setting section configured to set the condition for cancellation of battery charging prohibition.

6. The electronic apparatus of claim 1, further comprising
a peak shift function setting section configured to set whether to render a peak shift function valid.

7. The electronic apparatus of claim 2, wherein
the battery 22 is charged with power higher than the calculated average power consumption during a time when the battery charge is not prohibited.

8. A control method of an electronic apparatus comprising:
determining whether a current time is in a battery charging prohibition time slot and whether the current time slot is different from a peak shift time slot;
calculating an average power consumption while the electronic apparatus is powered on when the determining step determines that the current time is in the battery charging prohibition time slot;
detecting whether the electronic apparatus is in a power-off state or a sleep state; and
controlling charging of the battery with power lower than the calculated average power consumption when the detecting step detects that the electronic apparatus is in a power-off state or a sleep state.

9. A control program of an electronic apparatus for controlling the electronic apparatus so that the electronic apparatus executes the steps of:
determining whether a current time is in a battery charging prohibition time slot and whether the current time is different from a peak shift time slot;
calculating an average power consumption while the electronic apparatus is powered on when the determining step determines that the current time is in the battery charging prohibition time slot;
detecting whether the electronic apparatus is in a power-off state or a sleep state; and
controlling charging of the battery with power lower than the calculated average power consumption when the detecting step detects that the electronic apparatus is in a power-off state or a sleep state.
